(19) United States
(12) Patent Application Publication
(10) Pub. No.: US 2008/0032392 A1
(43) Pub. Date: Feb. 7, 2008

(54) COVERING DEVICE

(76) Inventors: Ambros Bauer, Warngau (DE); Markus Binding, Gruenbach (DE)

Correspondence Address: W. L. Gore & Associates, Inc., 551 Paper Mill Road, P.O. Box 9206, Newark, DE, 19714-9206, US

(21) Appl. No.: 11/869,939

(22) Filed: Oct. 10, 2007

Related U.S. Application Data
(62) Division of application No. 10/536,299, filed on Dec. 9, 2005.

(30) Foreign Application Priority Data
Nov. 27, 2002 (DE) 102 55 509.5

(51) Int. Cl. C05F 17/02

(52) U.S. Cl. 435/290.1

(57) ABSTRACT

The invention relates to a covering construction in a flexible device for covering heaped or stacked material, in particular for the aerobic treatment of organic-containing waste, for example residual waste or domestic refuse, in a compost heap. The covering construction has a cover which comprises a number of support elements which can be filled with at least one fluid and are connected to one another at least in part, and also at least one waterproof and gas-permeable sheet which is connected to the support elements. The device forms an erected state and a lowered state, depending on whether the support elements are filled or not. The sheet covers the material and undergoes a raising and lowering process via the filling and emptying of the support elements.

### RELATED APPLICATION

The present application is a divisional application of U.S. patent application Ser. No. 10/536,299, filed May 24, 2005.

### FIELD OF THE INVENTION

The invention relates to a construction in a flexible device for covering heaped or stacked material, in particular for the aerobic treatment of organics-containing waste, for example residual waste or domestic refuse in a compost heap.

### BACKGROUND OF THE INVENTION

In the field of waste treatment, various devices and processes are known for drying and degrading biological constituents of solid municipal waste. A known device is a closed system and comprises composting in compartments, containers or boxes of closed constructions. A disadvantage of this closed system is the high capital costs for procuring such a device and also the costs which arise from removing and purifying the waste air produced within the system.

Another simpler device comprises open composting in compost heaps in the open air. However, in this case problems arise with control of microbial emission and odor, since all of the gases produced can escape unimpeded into the atmosphere. To alleviate these problems, for some years large permeable covers have been used which completely cover the compost heaps. Permeability of these coverings is selected so that the compost heap can be actively aerated and at the same time protection against microbial emission and odor is provided. For example, DE 4231414 C2 describes a covering for a compost heap having a waterproof and gas-permeable membrane laminate. Such coverings, however, have various disadvantages. Firstly, the compost heaps are charged and covered at different times, that is to say the heap must firstly be fully charged before the cover can be drawn across it. For as long as the open uncovered heap has air freely flowing over it, this leads to unwanted emission. Furthermore, to remove material from the heap the covering must be removed from the heap, so that the removal equipment has free access to the compost heap and does not cause damage to the covering. The removal of the covering in turn leads to unwanted emission. In addition, the complex, at least partially manual handling during the laying and removal of the cover is a considerable personnel expenditure. Handling the covering is made more difficult by the great height of the fill. In addition, weights at the rim to hold down the cover, for example water-filled fire hoses and sandbags, must be removed and then replaced. Even when mechanical winding machines are used, advantageously, at least two people are required. Furthermore, rolling up and unrolling the cover can lead to damage of the tarpaulin material which greatly reduces the functionality of the cover, in particular in the case of a membrane material. Also, from the point of view of safety at work, operating with covers on compost heaps is not without problems for the workers involved. Firstly, there is a risk of accidents in stepping on and crossing the heap. Secondly, the workers, in the case of an uncovered heap, have direct contact with the material to be covered and the escaping emission, which is a health risk for the workers.

In a further development, compost boxes are provided with a covering. In the case of the folding-lid box described in DE 29616788 U1, a roof construction is provided which is equipped with waterproof and air-permeable membrane laminates. However, the folding-lid box requires expensive materials for walls and roof construction. Furthermore, there is still an emission problem during the filling and emptying operations, since the folding lid must be open to allow sufficient height of passage for wheel loader operations.

Emissions are taken to mean, in summary, the escape of dusts, aerosols, odors, microorganisms, fungal spores, seeds and the like.

### SUMMARY OF THE INVENTION

It is an object of the present invention, therefore, to provide improved covering of heaped or stacked material using covers, which permits simpler and gentler handling of the cover.

It is a further object to decrease odor and microbial emissions during charging and removing material from heaps made of organic waste.

It is a further object of the present invention to provide cost-effective and inexpensive covering of heaped or stacked material which overcomes the above described disadvantages of the prior art.

The object is achieved according to the invention by the features of claim 1 and also by the features of the device claim 21 and the process claim 43. The dependent claims specify advantageous developments of the invention.

The object is achieved by a covering construction for heaped or stacked material, the covering construction has a cover which is formed from a number of support elements which can be filled with at least one fluid and which are at least in part joined to one another, and also at least one waterproof and gas-permeable sheet, which sheet is connected to the support elements.

The covering construction forms a device which can be erected in a flexible manner for the aerobic treatment of heaped or stacked material in which the covering construction covers the material. Here the device has an erected state and a lowered state.

The erected state of the device is implemented by the support elements which are filled with at least one fluid under pressure. As a result the sheet is raised and forms a distance from the material. In the erected state the covering construction forms a hall or a space in which the material to be covered can be heaped or stacked. The raised sheet forms in particular a vehicle-accessible space around the material.

In the lowered state of the device, the support elements essentially contain no fluid, that is to say the support elements are emptied of the at least one fluid so that the sheet is lowered and covers the material. Then the cover rests on the material to be covered like a conventional heap covering.

The inventive covering construction is either fixed directly to the ground with corresponding devices or is a roof construction or is situated on corresponding surrounding walls.

The support elements are filled with at least one fluid in order to erect the covering construction. The fluid filling the support elements can be a gas, a vapor, a liquid or a gas and a liquid. This means that the support elements can be filled either with at least one gas or with at least one liquid or with at least one gas and at least one liquid. The support elements are made to be at least gas tight. Filling is performed under pressure so that the support elements rise to form a three-dimensional structure, for example a hall. The at least one waterproof and gas-permeable sheet fixed to the support elements is likewise raised together with the support elements.

The size of the construction is chosen so that a space of sufficient height is formed so that introducing the material to be covered by wheel loaders, feed belts and conveyor belts or similar transport machines can be performed. After the heap has been erected, the at least one fluid is removed from the support elements as far as possible, so that the construction collapses in a controlled way and covers the heap. Using gathering mechanisms, the waterproof and gas-permeable sheet comes to lie directly on the surface of the heap. To empty the heap, again the inventive device must be brought at least temporarily into the erected state.

The inventive construction and flexible device makes an inexpensive, simple and gentle handling of the cover possible. The cover is formed by the combination of support elements and waterproof and gas-permeable sheet. The sheet, via the filling and emptying of the support elements, undergoes a gentle raising and lowering operation. This raising and lowering operation replaces the complex and material-demanding process of pulling together or rolling up and unfolding of the cover in the prior art. Furthermore, wheel loaders or other transport machinery can be used for building up and dismantling of the compost heap without the cover having to be removed completely. Instead, the sheet is raised and the resultant space is accessible for material-introducing machines such as wheel loaders. The inventive construction can thus remain on site and need not be packed and moved, as with the known cover, for building and dismantling the compost heap.

The inventive device combines the advantages of a closed system with the advantages of the known simple heap covering. Firstly, even in the erected state the device remains very largely closed off from the environment. This is due to the fact that the sheet of the inventive device is not only stretched out around the compost heap in the erected state but also lies on the compost heap or is piled around the heap in the lowered state, so that the heap is always surrounded by the sheet. The polluted air thus remains substantially within the inventive device. Only in the erected state is the device opened at the side temporarily for building up or removing the material to be covered. During the temporary opening of the side, in contrast to complete exposure of the material in the prior art, greatly decreased emission, such as odor and microbial emission, to the surrounds takes place. In addition, an exhaust system can be installed for the first time in a heap covering, in order to capture by means of reduced pressure any emissions that might have been carried over by wheel loader traffic when the covering is in the erected state, and feed it to an adjacent exhaust air cleanup system. Secondly, the device permits highly mechanized introduction and removal of the material to be covered involving minimum labor costs, since at most only one person with a wheel loader is required or the room is charged and emptied via automatic feed belts. By this means, also, the workers no longer come into direct contact with the material to be covered, which is an improvement in safety at work.

Additionally, the inventive device corresponds in the lowered state to a customary heap covering. The sheet lies directly on the material to be covered and enables water vapor to be discharged through the sheet to the environment. Furthermore, the fact that the construction lies directly on the compost heap means that the entire device is less wind susceptible.

At the same time the sheet acts as a protective barrier inward and outward. Inward, the sheet protects against the ingress of water and against drying out in the event of strong solar radiation. Outward, the sheet protects against the exit of microbial emissions and odors, and because of its gas permeability the CO₂ formed in the device by aerobic degradation can escape through the sheet without pressure buildup occurring on the sheet.

In one embodiment, the covering construction has at least one fluid inlet for filling the support elements at a pressure such that the sheet can be raised by the support elements. The covering construction addition-ally has at least one fluid outlet for emptying the support elements so that the sheet can be lowered by the support elements. The at least one fluid inlet is an opening in at least one support element and ensures the feed of at least one fluid under pressure. For this the fluid inlet is connected to a ventilator fan or compressor which forces the at least one fluid under pressure into the support elements via the fluid inlet. Each support element can have a separate fluid inlet. Preferably, there is one fluid inlet in one support element and corresponding liquid distributors between the support elements.

The at least one fluid outlet can have a conventional valve which is likewise situated in at least one support element. In one embodiment, each support element has its own valve.

In a further embodiment the fluid inlet is at the same time the fluid outlet also. The support elements are then emptied either passively via the ventilator fan or actively by the suction operation of the ventilator fan.

The covering construction forms, with the raised sheet, a closed vehicle-accessible space over the material. Vehicle-accessible space here means that the space is constructed so that persons and/or vehicles of any type can enter or drive into it in order to move the material into or out of the space. This means that the space has a sufficient height and width. In one embodiment, the space has a height above the ground of at least 6 m. Closed space means that the cover, that is to say support elements and sheet, is stretched by the raising, so that walls and/or a roof are formed, so that the material, even in the erected state, is completely surrounded by the cover and does not come into contact directly with the surrounds. Furthermore, the device has at least one closable opening through which the material can be transported into or out of the space. This opening is only open temporarily for vehicle access of the space, but otherwise is kept closed so that the interior of the space does not have direct contact to the surrounds.

As a result of the raising and lowering operations of the sheet, a variable space between material to be covered and the sheet can be set. Depending on requirements, this space can be chosen so that the sheet lies closely on and around the material to allow for a optimum degradation process of the organic constituents. The space can also be selected so that a high closed and vehicle-accessible space is formed around the material so that the material can be moved into or out of the space. The spacing between raised sheet and material can be, for example, at least 2 m.

Preferably, the waterproof and gas-permeable sheet is a laminate having a porous layer which is joined to at least one textile layer. The use of a textile laminate is particularly advantageous, since, in addition to the high waterproofness and simultaneous gas permeability, the porous layer is particularly suitable for simultaneous retention of emissions such as, for example, odors and microbes. Preferably, the porous layer is a microporous membrane.

The gas-permeable sheet has a resistance to water vapor permeation of less than 20 m² Pa/W and thus ensures high water vapor permeation through the sheet. The low resistance to water vapor permeation enables wet material to dry or for the removal of existing process water. Additional watering down and lump-formation of the material is effectively prevented. Furthermore, the sheet has an air permeability between 3 and 100 m³/m²/h at a pressure difference of 200 Pa. This water vapor permeation and also the air permeability ensures that the material to be covered is sufficiently aerated, that is to say is sufficiently supplied with oxygen and conversion products can escape without pressure buildup. Furthermore, the sheet is waterproof at a water ingress pressure of greater than 10 kPa. This ensures protection from watering down by precipitated water.

The support elements are connected to one another at least in part. Preferably, the support elements are connected to one another so that they have a common flow cross section. In a further embodiment, the support elements are connected to one another by a fluid distributor. As a result, for filling the support elements, only one unit, for example a ventilator fan, is required, which fills the entire support elements of the inventive construction with at least one fluid. Another embodiment provides that, although the support elements are connected to one another, each support element has a separate unit for filling.

The support elements, in a preferred embodiment, are tubes. In one embodiment the flexible tubes can be inflated with gas, preferably with air, the ventilator fan then merely supplying ambient air to the flexible tubes. The use of air is particularly cost-effective. To achieve sufficient stability of the device in the erected state, the at least one fluid must be fed to the support elements at a sufficient pressure, so that preferably an internal excess pressure of 200 Pa is present. In a further embodiment this pressure is at least 10 kPa, preferably 12 kPa. The flexible tubes have a diameter of greater than 80 cm, preferably the diameter is 100 cm. If the stability of the flexible tubes permits, obviously a smaller flexible tube diameter at a higher pressure can also be employed.

The support elements have a top side and a bottom side, the bottom side being directed toward the material to be covered and the top side to the surrounds. The sheet is preferably attached to the bottom side of the support elements. The waterproof and gas-permeable sheet thus comes to lie directly on the surface of the material to be sealed and ensures high passage of water vapor and gas. At the same time, the support elements, in the case of a partially coarse particulate bulk material, cannot dig into this.

In the erected state of the inventive device, the covering construction preferably forms a roof area and a wall area, the sheet being arranged at least in the roof area. The use of sheet in the roof area is sufficient in most cases, since in the lowered state predominantly only the roof area and the sheet present there lies on the surface of the material to be covered. In contrast thereto, the covering construction in the wall area essentially folds up around the heap in the lowered state and thus cannot actively act on the material to be covered. With this design, the amount of material for the waterproof and gas-permeable sheet can be saved, which brings considerable cost advantages, in particular when membrane material is used. In the wall area, instead of the waterproof and gas-permeable sheet, a merely waterproof but rip-proof and abrasion-resistant support layer is attached to the support elements. Thus additional protection of the device from any damage due to machinery during the loading and unloading of the material to be covered is achieved. Thus the cover in one embodiment can have a waterproof and gas-permeable sheet and a waterproof protective layer.

The sheet is preferably detachably attached to the support elements, so that in the event of damage, breakage or fouling of the sheet this can be replaced in a simple manner. In the case of replacement, the device is brought into the erected state in order to permit easy access to the sheet to be replaced.

The inventive device can additionally be fitted with waste-treatment devices, such as spraying and watering tubes or an exhaust air and suction device.

In addition, an approach wall can be provided on the inside of the device, which is preferably formed by a number of adjacently placed concrete elements. This approach wall, in the erected state, is an effective protection against damage of the device by wheel loaders. Furthermore, the approach wall, as edge delimitation of the heap, is an orientation aid for the wheel loader driver.

The edge material of the device can be fastened to the ground by simple means such as soil nails, tent pegs or weight elements incorporated into the edge material or tubes in/on the edge material which are to be flooded. In a further embodiment, the device is attached to or on walls which enclose a site for erecting a heap. Such enclosing walls can have a height of 1 m-2 m. Further attachment means for mounting the covering construction to walls can be, for example, abrasion-resistant and airtight bags into which the ends of the support elements are inserted, the bags being directly attached to the walls.

In particular, the attachment is made in an airtight manner such that the device can accommodate pressures up to 2000 Pa in its interior and despite this is sufficiently gastight with respect to leakages.

An inventive process for handling a device for the aerobic treatment of heaped or stacked material has the following steps: provision of a covering construction having a cover, the cover having a number of support elements which can be filled with at least one fluid and are connected to one another at least in part and having at least one waterproof and gas-permeable sheet which is connected to the support elements; erecting the covering construction by filling the support elements with at least one fluid at a pressure such that the sheet is raised and forms a space; introducing the material into the space; lowering the construction by letting out the at least one fluid from the support elements, the sheet being lowered and the material being covered with the sheet.

Before the material is introduced, an opening into the space is opened, this opening is closed again before or during the lowering of the covering construction.

### DEFINITIONS

Water Ingress Pressure Test

The water ingress pressure test is a hydrostatic resistance test which is essentially based on water being pressed against one side of the material sample and the other side of the material sample being observed for the passage of water.

The water pressure is measured according to a test method in which distilled water, at 20±2° C., on a material sample of an area of 100 cm², is exposed to increasing pressure. The water rising pressure is 60±3 cm of H₂O/min. The water pressure is then the pressure at which the water appears on the other side of the sample. The exact procedure is regulated in ISO standard No. 811 from 1981. “Waterproof” is taken to mean that a material withstands a water ingress pressure of at least 10 kPa.

“Porous” is taken to mean a material which has very small microscopic pores through the inner structure of the material and the pores form a continuous connection or path, joined to one another, from one surface to the other surface of the material. In accordance with the dimensions of the pores, the material is thus permeable to air and water vapor, but liquid water cannot pass through the pores.

The pore size can be measured with a Coulter Porometer™, manufactured by Coulter Electronics, Inc., Hialeah, Fla. The Coulter Porometer is an instrument which provides an automatic measurement of pore size distribution in porous media according to the method described in ASTM standard E1298-89.

However, the pore size cannot be determined by the Coulter Porometer for all available porous materials. In such cases, the pore sizes can be determined using a microscope, for example a light microscope or electron microscope.

When a microporous membrane is used, this has a mean pore size of between 0.1 and 100 μm, preferably the mean pore size is between 0.2 and 10 μm.

Resistance to Water Vapor Permeation Ret

The Ret value is a specific material property of sheets or composite materials which determines the flux of latent heat evaporation through a predetermined surface at a constant partial pressure gradient.

A material is defined as “permeable to water vapor” if it has a resistance to water vapor permeation Ret of less than 150 (m²×Pa)W. Preferably, the sheet has an Ret of less than 20 (m²×Pa)W. The water vapor permeability is measured by the Hohenstein MDM dry method, which is described in standard test procedure No. BPI 1.4 (1987) of the Bekleidungsphysiologisches Institut [Apparel Physiology Institute] e.V. Hohenstein.

Air Permeability

The air permeability is reported in m³/h per m² of sheet and is determined using an air permeability test instrument from Textest Instruments (FX 3300), Zurich. The air permeability is determined on the basis of ISO 9237 (1995).

A material is termed “air permeable” if it has an air permeability between 3 and 100 m³/m²/h at an applied pressure difference of 200 Pa.

The term “flexible” is used in the present invention to characterize the device as a foldable, assemblable and collapsable three-dimensionable structure.

### DETAILED DESCRIPTION OF THE FIGURES

The invention is now to be described in more detail on the basis of drawings:

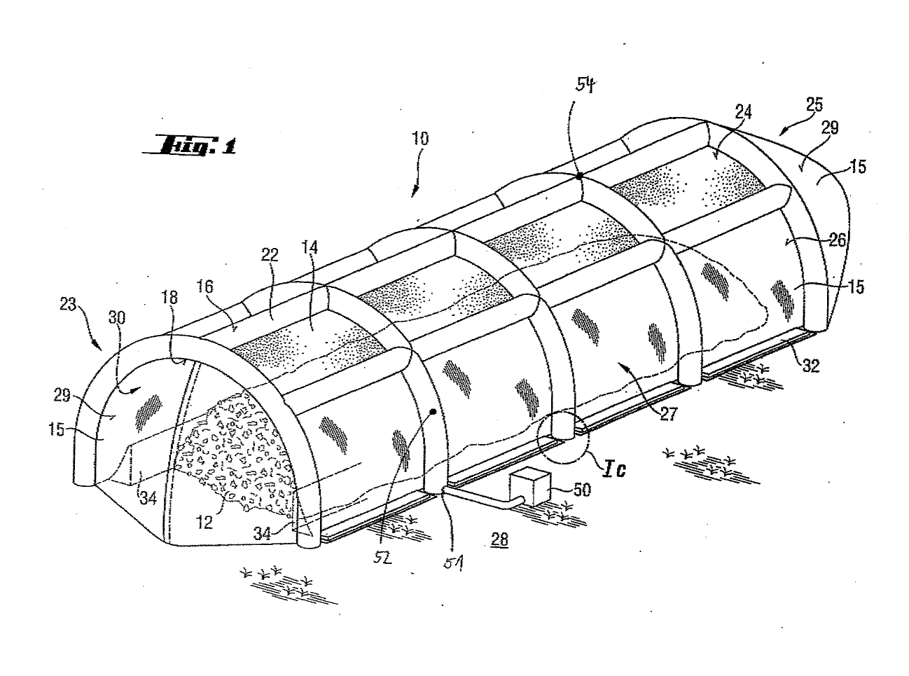

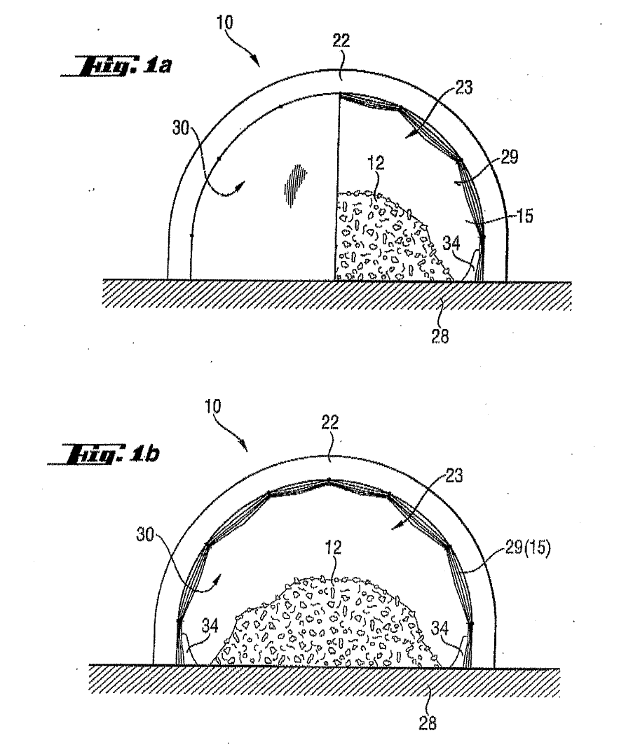

FIG. 1 shows a diagrammatic presentation of the inventive device in the erected state.

FIG. 1a shows a diagrammatic presentation of a first opening mechanism in an end wall of the inventive device.

FIG. 1b shows a diagrammatic presentation of a second opening mechanism in an end wall of the inventive device.

FIG. 1c shows an enlarged detail of FIG. 1 together with a preferred attachment device of the inventive device on the ground.

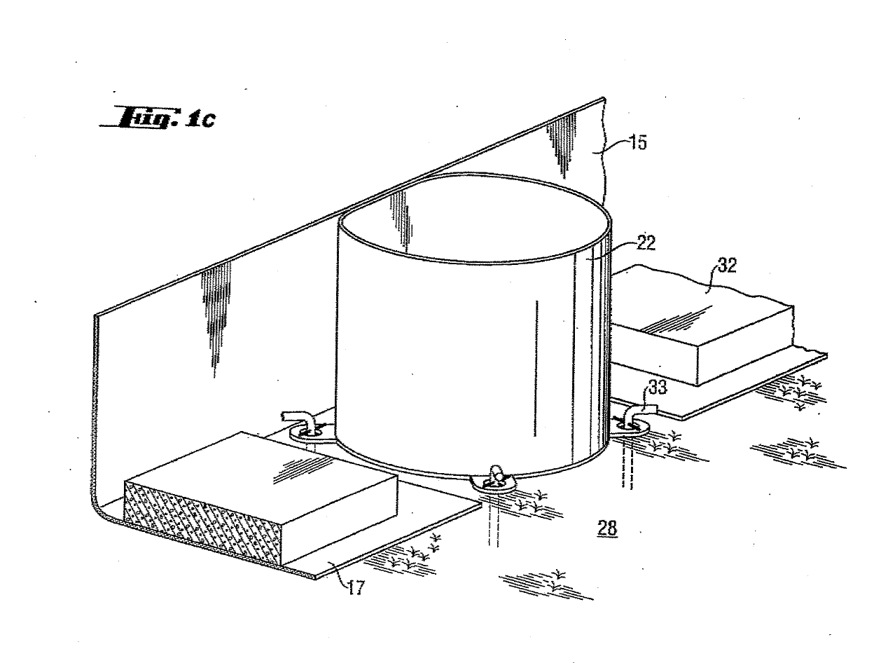

FIG. 2 shows a detail of a side view of the inventive device in the lowered state.

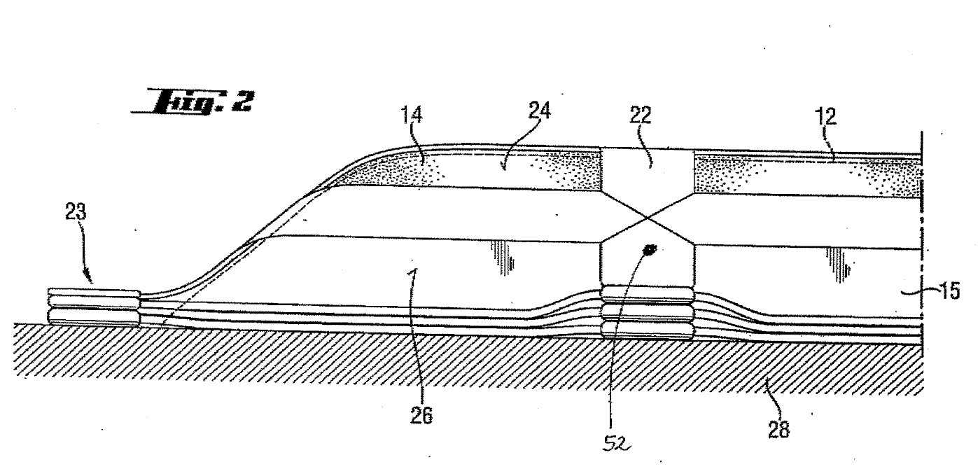

FIG. 3 shows a cross section through the inventive device in the lowered state.

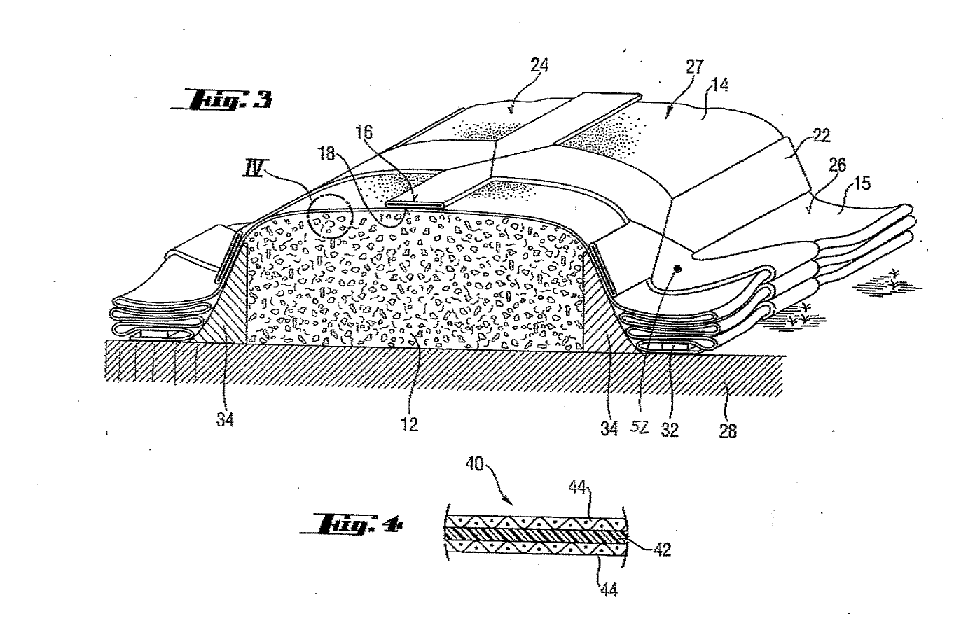

FIG. 4 shows a cross section through an embodiment of the sheet.

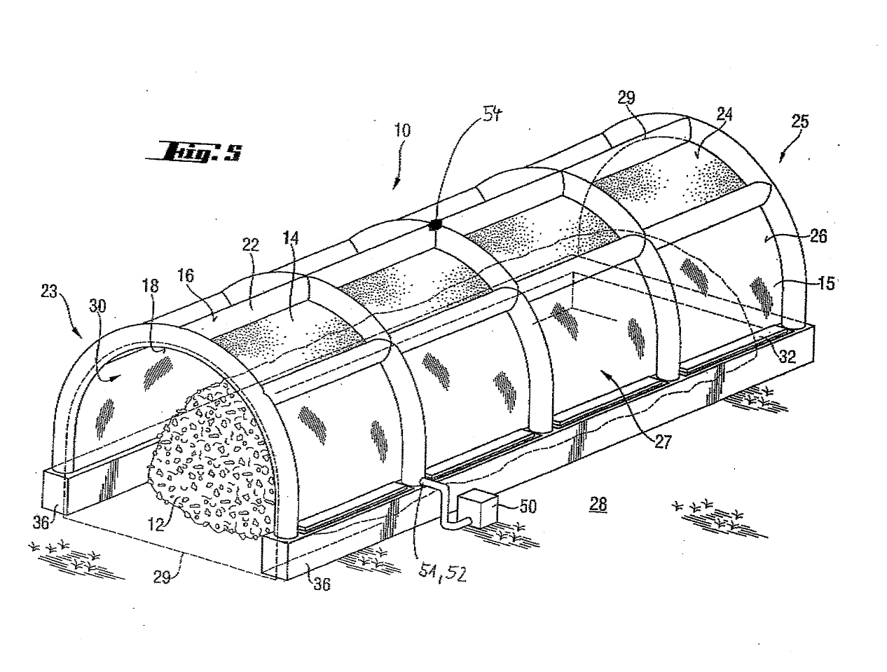

FIG. 5 shows a further embodiment of the inventive device in the erected state.

### DETAILED DESCRIPTION OF THE INVENTION

The present invention relates to an improved covering instruction for heaped or stacked material and also to a flexible device for the aerobic treatment of heaped or stacked material together with a corresponding process for using the covering construction. The term heaped or stacked material comprises all materials which can be heaped or stacked, for example soil, cereals, organics-containing waste such as domestic refuse, compost, hay, agricultural products, wood, stones, wooden beams or cuboid-shaped packed goods. The invention is directed in particular toward the aerobic treatment of organics-containing solid municipal wastes, but can be applied to any other heaped or stacked material, provided that it is necessary to the feed and remove gases in the treatment of this material and, in the case of aerobic waste treatment, in particular to feed oxygen and remove CO₂. The inventive construction and flexible device is also usable, in particular, for drying material.

The following descriptions of the figures describe the invention as exemplified by the treatment of compost, residual waste and domestic refuse, these materials generally being summarized under the terms material to be covered or (compost) heap.

FIG. 1 shows a diagrammatic presentation of the inventive flexible device. The device is essentially composed of a covering construction (10) having a cover. The cover has a number of support elements (22) which can be filled with at least one fluid and are connected to one another at least in part and at least one waterproof and gas-permeable sheet (14) connected to the support elements (22). The covering construction (10) is attached essentially air-tightly to the ground (28) by the end regions of the construction (10) being fixed directly to the ground (28) with corresponding attachment devices (32) or on enclosure walls (36) (see FIG. 5).

The inventive flexible device can assume two states. The first state is presented in FIG. 1 and shows the construction (10) in an erected state. In the erected state, the support elements (22) are filled with at least one fluid under pressure and form a three-dimensional structure which rises above the ground (28) in the shape of a hall. The sheet (14) which is connected to the support elements (22) likewise rises above the ground (28) together with the filled support elements (22). This interaction of the filled support elements (22) with the sheet (14) causes the device to form a closed, vehicle-accessible space (30) in which the material to be covered is situated, preferably in the form of a compost heap (12). In one embodiment, a ventilating fan (50) is attached outside the device to a support element and supplies the support elements (22) with at least one gas.

In the second state, the construction (10) is in a lowered state, as presented in FIGS. 2 and 3. In the lowered state, the support elements (22) are essentially empty, that is to say essentially no longer filled with at least one fluid. The construction (10) collapses in the lowered state and the waterproof and gas-permeable sheet (14) comes to lie on the surface of the compost heap (12). Using gathering mechanisms, the waterproof and gas-permeable sheet (14) comes to lie on the surface of the compost heap. Additional straps can protect the covering construction from gusts of wind. In certain situations, a small variable distance between the sheet and the surface of the heap can be set, for example to prevent the sheet from freezing to the heap, or to achieve a higher resistance with respect to water vapor permeability of the sheet.

By means of such as construction, the device is able to raise or lower the sheet (14), depending on whether the support elements (22) are filled or not with at least one fluid.

The fluid filling the support elements (22) can be a gas, a vapor, a liquid, or a gas and a liquid. This means that the support elements (22) can be filled either with at least one gas or with at least one liquid, or with at least one gas and at least one liquid. The support elements (22) are constructed so as to be at least gastight.

In the design in FIG. 1, the device forms a semicircular tunnel having a front area (23) and an end area (25). Depending on the design of the support elements (22) and of the sheet (14), the device in the erected state can have any desired shape, for example cuboid, dome-shaped, conical, or pyramidal designs.

In an embodiment according to FIG. 1, the construction (10) forms a roof area (24) and at least one wall area (26). Roof area (24) is taken to mean a part of the construction (10) which, in the lowered state, lies directly on the surface of the compost heap (12). Wall area (26) is taken to mean the area of the construction (10) which forms a lateral demarcation of the device. In the lowered state, the wall area (26) runs folded around the compost heap (12) and closes it off completely. In the erected state, the wall area (26) forms two opposite tunnel walls (27) and two opposing end walls (29).

In order to reach the interior of the inventive device, provision is made_for at least one end wall (29) to be opened. This opening must be at least large enough so that a wheel loader can drive into the interior. Preferably, the space (30) has at least one closable opening. This opening is only opened when there is actually a need to enter the space (30). In the intervening time, the device, even in the erected state, is completely closed off all around. Advantageous opening mechanisms are shown in FIGS. 1a and 1b. In FIG. 1a, the end wall (29) is closed in the front area (23) by two sheet parts which are detachably connected to one another. The sheet parts are attached airtightly to a support element (22). An opening is formed by opening the sheet parts, for example via a zip or velcro fastener and each part is gathered together and fastened at the side to the support element (22) like a curtain. In FIG. 1b, the end wall (29) is formed from a sheet part and, using a gathering mechanism, is drawn up and gathered together along the inner periphery of the support element (22). The gathering can be performed manually or automatically. In one embodiment, the end wall is gathered automatically via the erection operation of the covering construction. In the erected state, the opening is also reclosable automatically.

Preferably, the end walls (29) are made of a waterproof textile (15). Of course, it is also possible to provide the end walls (29) in the front area (23) and the rear area (25) with an opening mechanism.

Preferably, the waterproof and gas-permeable sheet (14) is arranged at least in the roof area (24), since this area in the lowered state lies on the surface of the compost heap (12) and has to effect gas exchange with the surrounds. In this case, the wall area (26) is formed from a waterproof and foldable protective layer (15). This protective layer (15) comprises a robust and abrasion-resistant material and protects the device in the erected state against fouling and damage by machinery and plant.

Preferably, the space (30) is designed such that loading and unloading machinery for the material (12) to be covered, for example wheel loaders, can drive into the space. To prevent the wheel loaders from damaging the sheet (14) in the wall area (26), in particular the protective layer (15), along the inside of the tunnel walls (27), in addition, approach walls are provided as lateral delimitation. These approach walls are preferably formed from a number of adjacently arranged elements, for example concrete elements (34). At the same time, the approach walls act as an orientation aid for the wheel loader driver.

In a further embodiment, the sheet (14), in the roof area (24), contains a translucent material, for example transparent films, translucent permeable laminate or a PVC window. This translucent material occupies at most 5% of the area of the roof area (24), so that the gas-permeable function of the entire sheet (14) is not significantly impaired.

The inventive device can have as many support elements (22) as desired. However, at least two support elements (22) are required to enable sufficient attachment of the sheet (14) and to give the entire device the necessary stability. In FIG. 1, preferably vertically and horizontally arranged support elements (22) are present, which are arranged crosswise to each other. The support elements can also run at an incline at a defined angle to the ground.

The support elements (22) have at least one fluid inlet (51) and at least one fluid outlet (52). In one embodiment, the fluid inlet (51) is also at the same time the fluid outlet (52). Each support element can have a separate fluid inlet (51) and fluid outlet (52), or if the support elements are connected to one another in such a way that the fluid can flow through all support elements, one fluid inlet (51) and one fluid outlet (52) are sufficient for all support elements. The fluid inlet (51) is an opening in a support element into which or onto which a connecting piece to the ventilator fan (50) is welded. The connecting piece can be, for example, a PVC tube. The fluid outlet (52) is a commercially conventional valve, for example from Scoprega S.p.A., Milan, Italy.

The support elements (22) are connected to one another at least in part, this comprising all embodiments in which the support elements (22) are connected directly to one another at their contact points, the support elements (22) are connected to one another at individual contact points, only individual support elements are connected to one another, or the support elements (22) are connected to one another indirectly via aids, for example connection strips, connection rails or connection cords. The support elements (22) can be connected to one another, for example, only via the sheet. Preferably, each support element (22) is connected to a neighboring support element (22) at individual contact points. The connection of the support elements (22) causes, in the erected state, a stable and self-supporting construction to be formed. In one embodiment, the support elements (22) lie over one another at their crossing points or contact points and are connected to one another in such a manner that the contacting surfaces of the horizontal and vertical support elements (22) are glued, sewed, welded to one another or are connected to one another in another manner.

In another embodiment, the support elements (22) are connected to one another at their crossing points or contact points in such a way that the cross sections of the horizontal support elements penetrate into the cross sections of the vertical support elements. By this means, the at least one fluid can flow from one point through the entire construction of the support elements (22). This is particularly advantageous, because only one ventilator fan (50) needs to be connected to the inventive device. Furthermore, this structure is particularly stable, since an advantageous pressure distribution is set.

In a further embodiment, only individual vertically erected support elements are provided which are connected to one another via a horizontal fluid tube. The fluid tube can run in the gable or in the vicinity of the ground and distributes the fluid which flows in via the fluid inlet (51) to all support elements. The fluid tube is preferably a rigid plastic or metal tube which withstands the pressure present at the fluid inlet (51). However, it can also be fabricated from flexible gastight materials.

Finally, the support elements (22) can be arranged with respect to one another in any desired arrangement provided that in the erected state a three-dimensional structure is created.

The support elements (22) can be filled with at least one fluid, such as liquids or gases, that is to say they must have a cross section through which gases or liquids can flow. Any reinforcing elements in the interior of the support elements (22) shall not impair significantly the ability for flow to pass through. For a sufficient stability and supporting area for the sheet (14), the cross section of the support elements (22) should have a diameter of at least 10 cm. Preferably, the diameter is 50 cm. In a further preferred embodiment, the support elements have a diameter of at least 80 cm, preferably the diameter is between 90 cm and 110 cm.

The support elements can have any three-dimensional structure, for example flexible tubes or other hollow bodies. The support elements (22) are, in a preferred embodiment, flexible tubes. The support elements (22) can have any desired cross sectional shape, a round cross section being particularly preferred. A round cross section is simple to manufacture and permits optimum pressure distribution within the support elements (22). The support elements can also have, for example, an oval cross section.

In one embodiment, the support elements (22) are gas-inflatable flexible tubes. The gas used is preferably air which has a excess pressure of at least 200 Pa in the support elements (22). Preferably, the air has a excess pressure of at least 10 kPa. In addition to air, helium or other available gases can also be used.

In a further embodiment, the support elements (22) can be filled with a liquid, for example water.

The support elements (22) can also be filled with a liquid and a gas, in which case, then, preferably the liquid is introduced into a lower part of the support elements (22) and the gas is introduced into an upper part of the support elements (22). In this case, the lower part comprises the area of the support elements (22) close to the ground, for example the wall area (26), and the upper part comprises an area far from the ground, for example the roof area (24). This has the advantage that the liquid at the same time stabilizes the device on the ground (28).

To prevent an excessive pressure in the support elements, at least one excess pressure valve (54) is provided. This at least one excess pressure valve (54) opens, for example, at an internal pressure of greater than 25 kPa and thus prevents possible destruction of the support elements due to excess pressure. For example, an excess pressure valve from Halkey Roberts, St Petersburg, Fla., USA, can be used.

The material used for the support elements (22) is a waterproof and airtight material, for example a PVC-coated support sheet. The material should be sufficiently weatherproof and wear-resistant to enable a long service life. Preferably, the material is flexible and thus foldable or drapable, so that in the lowered state the support elements (22) can collapse. The feature of drapability is of importance for the present invention, so that during and after emptying of the support elements (22), the collapse of the device is controllable, to achieve exact placing of the waterproof and gas-permeable sheet (14) on the surface of the compost heap.

The support elements (22) have an upper side (16) and a lower side (18), the lower side (18) being the surface of the support elements (22) which points toward the space interior in the erected state, and the upper side (16) being the opposite side of the surface of the support elements (22), which points toward the surrounds. The waterproof and gas-permeable sheet (14) of the inventive device (10) is arranged either on the upper side (16) or on the lower side (18) of the support elements (22).

In a further embodiment, the sheet (14) is arranged between the support elements (22), more precisely in such a manner that the surfaces delimited by the support elements (22) in the peripheral direction are filled by the sheet (14).

Preferably, the sheet (14) is situated on the underside (18) of the support elements (22). The sheet (14) can be fastened to the support elements (22) by any known type of fastening, these include possible types of fastening such as tying, sewing, gluing, welding, using press studs or magnetic buttons, using velcro fasteners, using hooks or zip. It must be ensured that fastening the waterproof sheet (14) does not lead to an impairment of its waterproofness. Preferably, the sheet (14) is detachably attached to the support elements (22) to enable easy and rapid change of the sheet (14) in the event of fouling or damage.

In one embodiment, the waterproof and gas-permeable sheet (14) covers the entire underside of the support elements (22).

In another embodiment, the sheet only covers the underneath of the roof area (24). This particularly cost-effective design additionally uses a waterproof protective layer (15) which is fixed in the wall area. This waterproof protective layer (15) is generally more cost effective than the sheet (14) and has a robust abrasion-resistant material, for example a PVC-coated support sheet. This achieves additional protection of the inventive device from damage to the side walls in the filled state by machinery and vehicles.

For sufficient aeration of a compost heap, the waterproof and gas-permeable sheet (14) has to have sufficient air permeability. In the case of a compost heap, this ensures the aerobic degradation processes of the organic constituents. Preferably, the air permeability of the sheet (14) is between 3 and 100 m³/m²/h at an applied pressure difference of 200 Pa. The sheet (14) is fluid-tight at a water ingress pressure of greater than 10 kPa, preferably greater than 50 kPa, in which case the water ingress pressure can go up to a value of 1 MPa.

The resistance to permeation of water vapor Ret of the sheet (14) is less than 15 m² Pa/W, preferably less than 10 m² Pa/W.

The sheet (14) is a gas-permeable and waterproof textile, a gas-permeable and waterproof membrane or a laminate with a gas-permeable and waterproof membrane.

The textile used can be a densely pressed or densely woven textile, for example a high-strength polyester sheet.

The sheet (14) must also be made from a flexible and thus foldable and drapable material so that in the lowered state, it can be placed on the surface of the compost heap (12) and also excess material of sheet (14) and support elements (22) can be folded around the compost heap (12).

Preferably, the liquidproof and gas-permeable sheet (14) used is a laminate (40) having a porous layer (42) and at least one textile layer (44). The pores of the porous layer must be sufficiently large to enable the necessary gas throughput. The porous layer is, for example, a material from the group of the polyolefins, polyesters, poly(vinyl chloride)s, poly(vinylidene chloride)s, polyurethanes or fluoropolymers. Preferably, the porous layer is a microporous membrane. Membranes are thin, light, flexible and drapable. In addition, they are permeable to water vapor, air-permeable and waterproof.

Preferred microporous membranes comprise fluoropolymers, for example poly-tetrafluoroe-thylene; polyolefins such as polyethylene or polypropylene; polyamides, polyesters; polysulfones, polyethersulfones and combinations thereof; polycarbonates; polyurethanes. Preferably, a membrane made of stretched polytetrafluoroethylene (ePTFE) is used. The membrane made of ePTFE has a thickness of 5-500 μm, preferably 15-60 μm.

This material is distinguished by a multiplicity of open cavities which are connected to one another, a large cavity volume and great strength. Expanded polytetrafluoroethylene (ePTFE) is soft, flexible, has stable chemical properties, high permeability to gases and vapors and a surface with good rejection of impurities.

Furthermore, this material is permeable to gas. The porosity and the pore size are selected so that the gas diffusion is not hindered. The mean pore size can be 0.1-100 μm, preferably 0.2-10 μm, determined by the above described Coulter test. The porosity is 30-90%, preferably 50-80%. At the same time, the material is waterproof. A process for producing such porous membranes from stretched PTFE is disclosed, for example, in the patents U.S. Pat. No. 3,953,566 and U.S. Pat. No. 4,187,390.

Preferably, the microporous membrane is provided with textile support material which gives the membrane additional protection and strength. The support material can be laminated via a continuous or discontinuous adhesive layer onto at least one of the surfaces of the membrane. Advantageously, the support material is a textile sheet made of woven or knitted materials, natural or synthetic textile materials. Grids and non-wovens can also be used. Suitable textile materials are particularly, polyesters, polyamides, polyethylene, polyacrylates, polypropylene, fiber glass; fluoropolymer or a woven textile made of PTFE. The support material is arranged on the outside facing the atmosphere. Alternatively, a further textile sheet can be arranged on the other membrane surface.

In a further embodiment, the sheet (14) is rendered oleophobic. The membrane is rendered oleophobic in such a way that the porosity of the membrane is not significantly decreased. Preferably, the membrane has an oil rate of >1, ideally the oil rate is >5, so that moistening and fouling with organic substances is permanently avoided. The oleophobic rendering is described, for example, in DE 43083692. A ePTFE membrane rendered oleophobic is particularly preferably used for the present invention. The oleophobic microporous membrane can comprise at least one laminated textile support layer.

In the case of textile support materials, comparably high oil rates are achieved by using commercially available fluorocarbon coatings. Usually, an oleophobic agent in liquid form is applied to the material to be rendered oleophobic, for example by dipping, impregnating, spraying, coating, painting, rolling.

A particularly preferred sheet (14) in the form of a three-layer laminate is shown in FIG. 4. Between two textile support materials (44), a waterproof, water vapor-permeable functional layer (42) is arranged. The functional layer contains a microporous membrane, preferably made of ePTFE. The pore size of the membrane is 0.1 to 100 μm, preferably 0.2 to 10 μm. Such a low pore size prevents microorganisms and bioaerosols from being able to penetrate to the exterior. At the same time, sufficient gas exchange with the surrounds is ensured.

Such a laminate is described, for example, in WO 01/21394 A1 and is available from W.L. Gore & Associates GmbH, Putzbrunn bei Munchen, Germany, under the name of Gore®-Cover.

FIG. 1 shows a preferred embodiment of the device (10), in which vertical and horizontal support elements (22) are arranged crosswise to one another and are connected directly to one another. The support elements (22) are air-inflatable flexible tubes, so that in the erected state of the support elements (22) these form a three-dimensional tunnel having a semicircular cross section. The vertically arranged flexible tubes, in the erected state, run in a semicircular path along the tunnel periphery and each respective flexible tube end of a vertically arranged flexible tube is fastened to the ground (28) with fastening devices (32).

The vertical flexible tubes are arranged at a distance from one another of, for example, at least 3 m and are fastened to the ground. One vertical flexible tube forms a front area (23) and one forms a rear area (25) of the device. The front area (23) also comprises an opening for pedestrian and/or vehicular access to the interior of the device. The opening can be provided as a separate gate in the sheet which folds out in the erected state and can then be operated.

The number of the vertical flexible tubes and also the distance from one another is determined by the size of the device.

The horizontal flexible tubes run transversely to the vertical flexible tubes, preferably they run at an angle of 90° between the vertical flexible tubes. The arrangement of the horizontal flexible tubes between the vertical flexible tubes is not fixed, but preferably the horizontal flexible tubes run in a row from the front area (23) to the rear area (25) of the device. In one embodiment, a row of horizontal flexible tubes runs along the highest point of the tunnel and forms a roof support element. Furthermore, one row each of further horizontal flexible tubes forms a delimitation between roof area (24) and wall area (26) of the device. The number of horizontal flexible tubes is also dependent on the size of the inventive device. The flexible tubes preferably have a diameter of 500 mm. Inflatable flexible tube constructions are obtainable, for example, from HS-Behältertechnik GmbH in Regensburg, Germany, or from Montfort Fahnen in Klagenfurt, Austria.

The edge areas of the inventive device are fastened to the ground (28) using fastening devices (32). Edge areas are taken to mean the areas of the device which, in the erected state, lie directly on the ground (28). This relates to not only the ends of the vertical support elements (22), but also to the peripheral edges of the sheet (14) or the protective layer (15). Fastening devices (32) are taken to mean soil nails or tent pegs, screws, nails, weighting elements incorporated in or laid on the edge area, flexible tubes to be flooded with water in/on the edge area or devices for creating magnetism or other gravity-enhancing forces. A possible variation of the fastening is described in DE 198 42 887 A1. A particularly advantageous fastening is that which seals the interior of the device waterproof and air-tight in such a manner that no leakage currents can escape. FIG. 1c shows a preferred variation for fastening the device. The flexible tube ends are fastened in this case to the ground (28) with tent pegs (33). The edge area (17) of the device (18) is folded so that it lies flat on the ground (28). Weighting elements (32) such as water hoses, sandbags, weights or beams, lie on the folded edge area (17) and thus hold the construction (10) firmly on the ground (28).

The dimensions of the inventive device are dependent on the respective intended use. Preferably, the filled device rises over a ground area of from 40 to 600 m². The device can reach a height of up to 6 m. In a preferred embodiment, the device can reach a height of up to 8 m or more.

In a further embodiment, the rear area (25) of a first device can be coupled to the front area (23) of a second device. This has the advantage that a plurality of inventive devices can be joined to one another to obtain larger devices. They can be joined, for example, via zips or velcro-type fasteners, the end walls (29) between the devices then being unnecessary.

FIG. 2 shows a detail of a side view of the device in the lowered state. In this state the support elements (22) are empty, that is to say they essentially contain no fluid. The sheet (14) essentially covers the surface of the compost heap (12), the sheet (14) lying directly on the material to be covered.

The lowered state is implemented by the self-emptying of the support elements, by, for example, switching off the ventilation fan. As soon as the applied pressure falls away, the fluid flows out of the support elements. The construction collapses. In another embodiment, the support elements can be emptied through at least one fluid outlet (51).

The wall area (26) of the device is formed by the protective layer (15). This waterproof protective layer (15) does not come to lie directly on the compost heap (12) and is without importance for air and gas exchange between the compost heap (12) and the surrounds. The protective layer (15) folds itself predominantly autonomously around the compost heap (12) during the collapse of the construction. The protective layer (15) is folded up in an ordered manner using gathering mechanisms or using elastic materials which pull the protective layer material together, so that the waterproof and gas-permeable sheet (14) lies on the surface of the compost heap (12). Gathering mechanisms can comprise bands, straps, traction ropes, pulley blocks or belts and also elastic bands. The device generally remains for several weeks in the lowered state until the aerobic degradation processes of the compost heap are completed.

FIG. 3 shows the cross section through the inventive device in the lowered state. The waterproof and gas-permeable sheet (14) is fastened on the lower side (18) of the support elements (22). In the roof area (24) the sheet (14) is formed from a three-layer porous laminate (40). The wall area (26) consists of a waterproof protective layer (15). The laminate (40), in the lowered state, lies directly on the surface of the compost heap (12) and ensures sufficient gas and air exchange. The support elements (22), in the roof area (24) rest flat on the laminate (40) and are folded over one another together with the protective layer (15) at the side of the compost heap (12). The folding is performed in such a manner that when the device is erected again, the material of the construction may be unfolded simply without resistance.

FIG. 5 shows a further embodiment where the inventive device is mounted on enclosure walls in the form of a U-shaped base (36). The base (36) is, for example, laid with bricks or poured from concrete and replaces the approach walls (34) in the embodiment of FIG. 1. The height of the base is preferably 0.5 m-1.5 m. The device otherwise corresponds to the device described in FIGS. 1 to 4. In a further design, the flexible tube ends of the support elements can be situated in bags, the bags being fastened to the enclosure walls.

A further embodiment provides for the covering construction to be mounted on an existing hall. For this, the hall has at least one side opening, for example an airtight rolling gate or rolling door. The front area of the device is fastened air-tightly to the opening. In the erected state of the device, only the opening to the hall is opened to introduce material into the device or remove material from it. The advantage of this embodiment is that contact with the surrounds is largely prevented, since when the device is opened, microbe- and spore-polluted air passes into the hall and there can be systematically sucked off from there.

1. A device for the aerobic treatment of heaped or stacked material (12) having a covering construction (10) which covers the heaped or stacked material (12),
the covering construction having a cover, the cover comprising a number of support elements (22) which can be filled with at least one fluid and which are connected to one another at least in part, and at least one waterproof and gas-permeable sheet (14) which is connected to the support elements (22),
the device having an erected state and a lowered state,
wherein in the erected state the support elements (22) are filled with at least one fluid under pressure in such a manner that the sheet (14) is raised and at a distance from the material,
and in the lowered state the support elements (22) are emptied of at least one fluid so that the sheet (14) is lowered and covers the material (12).

2. The device as claimed in claim 1, wherein the distance between raised sheet (14) and material (12) is at least 2 m.

3. The device as claimed in claim 1, wherein the raised sheet (14) forms a vehicle-accessible space (30) around the material (12).

4. The device as claimed in claim 3, wherein the space (30) has a height of at least 6 m.

5. The device as claimed in claim 1, wherein the device has at least one closable opening.

6. The device as claimed in claim 1 having at least one enclosure wall (36) which surrounds the material (12), wherein the covering construction (10) is fastened to the at least one enclosing wall (36).

7. The device as claimed in claim 1, wherein the waterproof and gas-permeable sheet (14) is a laminate (40) which comprises a porous layer (42) joined to at least one textile layer (44a, 44b).

8. The device as claimed in claim 7, wherein the porous layer (42) comprises a microporous membrane.

9. The device as claimed in claim 7, wherein the porous layer (42) is selected from the group of polyolefins, polyesters, poly(vinyl chloride)s, poly(vinylidene chloride)s, polyurethanes and fluoropolymers.

10. The device as claimed in claims 7 to 9, wherein the porous layer (42) comprises stretched polytetrafluoroethylene (ePTFE).

11. The device as claimed in claim 7, wherein the textile layer (44a, 44b) comprises polyester, polyacrylate, polypropylene, polyamides, polyethylene, glass fiber or fluoropolymer.

12. The device as claimed in claim 1, wherein the waterproof and gas-permeable sheet (14) has a gas permeability of between 3 and 100 m³/m²/h at 200 Pa pressure difference.

13. The device as claimed in claim 1, wherein the waterproof and gas-permeable sheet (14) has a liquid ingress pressure of greater than 10 kPa.

14. The device as claimed in claim 1, wherein the waterproof and gas-permeable sheet (14) has a resistance to water vapor permeation Ret of less than 20 m² Pa/W.

15. The device as claimed in claim 1, wherein the support elements (22) are inflatable flexible tubes.

16. The device as claimed in claim 15, wherein the flexible tubes have a diameter of >80 cm.

17. The device as claimed in claim 15, wherein the flexible tubes withstand a pressure of at least 10 kPa.

18. The device as claimed in claim 1, wherein the at least one fluid is a gas, a vapor, a liquid.

19. The device as claimed in claim 18, wherein the gas is air.

20. The device as claimed in claim 1, wherein the at least one fluid has a pressure of at least 200 Pa.

21. The device as claimed in claim 1 having a roof area (24) and a wall area (26), wherein the waterproof and gas-permeable sheet (14) is arranged at least in the roof area (24).

22. The device as claimed in claim 21, wherein a waterproof protective layer (14) is connected to the support elements (22) in the wall area (26).
